(19) United States
(12) Patent Application Publication
(10) Pub. No.: US 2026/0330404 A1
(43) Pub. Date: Oct. 22, 2026

(54) SYSTEM AND METHOD OF SOURCING MATERIALS

(71) Applicant: Freshtohome PTE Limited, Singapore (SG)

(72) Inventors: Jayesh Jose, Bangalore (IN); Shahnawaz Kadavil, Bangalore (IN)

(21) Appl. No.: 19/723,520

(22) Filed: Jun. 29, 2026

Related U.S. Application Data
(63) Continuation of application No. 18/649,275, filed on Apr. 29, 2024, now abandoned.
Application No. 18/649,275 is a continuation of application No. 17/743,252, filed on May 12, 2022, now abandoned.
Application No. 17/743,252 is a continuation of application No. 16/594,408, filed on Oct. 7, 2019, now abandoned.
(60) Provisional application No. 62/742,622, filed on Oct. 8, 2018.

(51) Int. Cl. G06Q 10/087; G06N 20/00; G06Q 10/083; G06Q 20/32; G06Q 30/0202; G06Q 40/12

(52) U.S. Cl. CPC G06Q 10/087; G06N 20/00; G06Q 10/083; G06Q 20/325; G06Q 30/0202; G06Q 40/12

(57) ABSTRACT

A system and method of sourcing materials by connecting or matching Sellers having present or expected inventory with Buyers having present or expected necessity while minimizing or eliminating the use of a third party intermediary are disclosed. In some implementations, a method of sourcing materials may generally comprise receiving bid information from a candidate Seller and demand data from a candidate Buyer, comparing the bid information and the demand data to match a portion of the candidate Seller’s inventory to the candidate Buyer’s need (to identify a transaction), allocating and routing the portion of the inventory to the candidate Buyer via a transportation carrier, and augmenting the historical data with information associated with the transaction.

### CROSS-REFERENCE TO RELATED APPLICATION

This application is a continuation of U.S. patent application 18/649,275, which is itself a continuation of U.S. patent application 17/743,252, which is itself a continuation of U.S. patent application 16/594,408 which claims the benefit of United States provisional patent application Serial No. 62/742,622, filed Oct. 8, 2018, the disclosures of which are hereby incorporated herein by reference in their entirety.

### FIELD OF THE DISCLOSURE

Aspects of the disclosed subject matter relate generally to sourcing materials, and more particularly to a system and method of sourcing materials by connecting or matching sellers having present or expected inventory with buyers having present or expected necessity while minimizing or eliminating the use of a third party intermediary.

### BACKGROUND

Sourcing materials is a common operation that presents logistical problems under the best of circumstances, and represents a significant challenge in many industries. Materials that are needed for a particular process or methodology must be available for processing to continue on pace, but stockpiling necessary materials can be costly and inefficient. For example, having an excess supply of materials, such that materials stores may be tapped when processing steps require, may involve expensive warehousing or other storage solutions to ensure that materials are available when needed, even if the need is not current. On the other hand, attempting to time the availability of materials to coincide with particular stages of processing is also challenging. Many industries have attempted “just in time” (or JIT) delivery methodologies, such that materials are delivered to a processing facility just as they are needed. In theory, this can reduce or minimize required storage space, but narrow temporal requirements can result in materials shortages and temporary slowing of processing. These challenges can be exacerbated, for instance, when the materials to be used are perishable or of limited “shelf life.”

For example, for organized wholesalers or retailers (“Buyers”) of food stuffs, sourcing of raw materials used in food or meal preparation (such as fish, meat, vegetables, or dairy products) directly from the farmers or fishermen (“Sellers” or “Producers”) can be a very difficult logistical challenge, at least due to the number of parties involved. For instance, a typical Buyer may need to engage many different Sellers in order to obtain sufficient loads or amounts of necessary products, ingredients, and other process-critical constituent components. Often, these disparate Sellers are geographically distant and deal in low volumes or quantities, such that a Buyer must obtain small batches from many dispersed Sellers to obtain necessary quantities. To mitigate this issue of dealing with a number of such distinct Sellers, some Buyers depend on sourcing from intermediaries, i.e., “middle men” who aggregate products from a variety of such smaller Sellers. This aggregation concept can work well in some circumstances, for instance, in the case of products that are not perishable or can be preserved for a long time with minimal or only small degree of simple processing (such as coffee or sugar).

In the case of perishable products, however, using aggregators in a supply chain can have deleterious effects. Inserting such intermediaries between the Producer and the Buyer leads to delays, for example, by increasing the time period between initial distribution from the Producer and ultimate delivery to the Buyer. Additionally, many products change hands multiple times, i.e., between the Producer and an intermediary, between multiple intermediaries, and (eventually) to a Buyer. Generally, the delay between Producer and Buyer varies directly with the number of transactions; the greater the number of transactions (e.g., between intermediaries), the greater the time delay in the shipment of the perishable product from the Producer to the Buyer.

In the case of perishable products or goods, this typical delay between Producer and Buyer directly leads to a reduction in the quality of the products by the time they arrive at the destination (i.e., the Buyer’s facility). In accordance with conventional supply chain methodologies, the typical delay also increases the ultimate cost of products, since the supply chain paradigm involves payment to multiple intermediary parties along the path from Producer to Buyer. Further, in the case of edible products, quality and taste are usually adversely affected since, to ensure that such perishable edibles retain some degree of freshness through the long supply chain, many intermediaries often “process” the raw perishable product with one or more of a variety of chemical preservatives as a means of extending shelf life. In India for example, Ammonia or Sodium Benzoate may be used by intermediaries to extend the shelf life of fish. In many cases, addition of such chemical preservatives is of concern to consumers, and may lead to health problems for those who consume chemically treated foods.

Some Buyers have attempted to bypass use of intermediaries by employing a large number of procurement agents; these agents deal directly with the Producers, but given the high number of Producers in a typical supply chain, such an approach requires a correspondingly high number of agents – raising costs for the Buyer. In particular, a people-intensive supply chain paradigm, particularly in the context of perishable food or other time-limited items, has not been successful for many Buyers, which is why many Buyers depend on intermediaries, with the common results of reduced quality, addition of chemical preservatives, or both.

Therefore, there is a need for an improved system and method of sourcing materials, such as a supply chain paradigm for Buyers that enables direct sourcing of perishable products from a number of discrete Producers such that perishable items may be delivered in a short period of time by minimizing or eliminating use of intermediaries.

### SUMMARY OF THE DISCLOSURE

The following presents a simplified summary of the disclosure in order to provide a basic understanding of some aspects of various embodiments disclosed herein. This summary is not an extensive overview of the disclosure. It is intended neither to identify key or critical elements of the disclosed embodiments nor to delineate the scope of those embodiments. Its sole purpose is to present some concepts of the subject matter in a simplified form as a prelude to the more detailed description that is presented later.

The present disclosure describes a system and method of sourcing materials by connecting or matching sellers having present or expected inventory with buyers having present or expected necessity while minimizing or eliminating the use of a third party intermediary. The disclosed system and method may allow Producers to dynamically bid, for example, using a computer system platform in a “reverse auction” methodology; as set forth below, such a platform may use machine learning, predictive analytics technology, or other metrology tools to predict Buyer demand and automatically to source (on behalf of such Buyers) from an appropriate or optimal set of Producers based upon a number of parameters such as price, quality, distance between a particular Producer and the Buyer, or a combination of these and other factors.

In accordance with one embodiment, a method of sourcing materials generally comprises: receiving bid information from a candidate Seller having an inventory of materials; receiving demand data from a candidate Buyer having a need for materials in the inventory; comparing the bid information and the demand data in accordance with historical data related to past transactions and market conditions; responsive to the comparing, matching a portion of the inventory to the candidate Buyer based in part upon the inventory, the need, and the historical data to identify a transaction; allocating the portion of the inventory and routing the portion of the inventory to the candidate Buyer via a transportation carrier; and augmenting the historical data with information associated with the transaction. In some implementations, the receiving bid information comprises receiving data from a software application executing on a remote device. The remote device may be a wireless telephone, a tablet computer, or a networked computing device.

In some implementations described below, the comparing comprises utilizing a machine learning algorithm to analyze the historical data. Some methods may further comprise predicting a future supply and a future demand for the materials in the inventory based on the historical data and the information associated with the transaction. The augmenting may be responsive to the predicting. Additionally or alternatively, the augmenting may further comprise storing the information associated with the transaction for subsequent use by the machine learning algorithm.

In accordance with another embodiment, a system of sourcing materials may generally comprise: a server platform to match a candidate Seller having an inventory of materials with a candidate Buyer having a need for the materials in the inventory, the server platform communicatively coupled with a remote device operated by the candidate Seller and communicatively coupled with a remote device operated by the candidate Buyer; wherein the server platform comprises: an order module receiving demand data from the candidate Buyer; an application program receiving bid information from the candidate Seller; and a machine learning algorithm comparing the bid information and the demand data in accordance with historical data related to past transactions and market conditions; the server platform including nontransient data and instructions causing a processing component executing the instructions to match a portion of the inventory to the candidate Buyer based in part upon the inventory, the need, the historical data, and output from the machine learning algorithm to identify a transaction, to allocate the portion of the inventory and route the portion of the inventory to the candidate Buyer via a transportation carrier, and to augment the historical data with information associated with the transaction.

In some such systems, the order module may receive demand data from a software application executing on the remote device operated by the candidate Buyer, and the remote device operated by the candidate Buyer may be one of a wireless telephone, a tablet computer, or a networked computing device. Similarly, the application program may receive the bid information from a software application executing on the remote device operated by the candidate Seller, and the remote device operated by the candidate Seller may be one of a wireless telephone, a tablet computer, or a networked computing device.

In some implementations, the machine learning algorithm outputs a prediction related to a future supply and a future demand for the materials in the inventory based on the historical data and the information associated with the transaction. The nontransient data and instructions may cause the processing component executing the instructions to augment the historical data in response to the prediction. The nontransient data and instructions may further cause the processing component executing the instructions to store the prediction and the information associated with the transaction for subsequent use by the machine learning algorithm.

In accordance with another embodiment, a nontransient computer readable storage medium encoded with data and instructions is disclosed, the data and instructions causing a processing element executing the instructions to perform a method comprising: receiving bid information from a candidate Seller having an inventory of materials; receiving demand data from a candidate Buyer having a need for materials in the inventory; comparing the bid information and the demand data in accordance with historical data related to past transactions and market conditions; responsive to the comparing, matching a portion of the inventory to the candidate Buyer based in part upon the inventory, the need, and the historical data to identify a transaction; allocating the portion of the inventory and routing the portion of the inventory to the candidate Buyer via a transportation carrier; and augmenting the historical data with information associated with the transaction.

As set forth below, additional data and instructions may cause the processing element to generate a prediction related to a future supply and a future demand for the materials in the inventory based on the historical data and the information associated with the transaction. Further data and instructions may additional cause the processing element to augment the historical data responsive to the prediction.

The foregoing and other aspects of various disclosed embodiments will be apparent through examination of the following detailed description thereof in conjunction with the accompanying drawing figures, in which like reference numerals are used to represent like components throughout, unless otherwise noted.

### DESCRIPTION OF THE DRAWING FIGURES

FIG. 1 illustrates a materials sourcing platform in accordance with aspects of the disclosed subject matter;

FIG. 2 illustrates a materials sourcing environment that includes a central controller communicably coupled to predictive analytics and sourcing engines, according to one illustrated embodiment;

FIG. 3 shows a materials sourcing system controller, according to one or more illustrated implementations; and

FIG. 4 illustrates a method of sourcing materials, according to at least one illustrated implementation.

### DETAILED DESCRIPTION

Certain aspects and features of the disclosed subject matter may be further understood with reference to the following description and the appended drawing figures. In operation, a system and method of sourcing materials may connect or match sellers having present or expected inventory with buyers having present or expected necessity while minimizing or eliminating the use of a third party intermediary.

By way of definition, a party seeking to enter into a commercial transaction (e.g., a Buyer or a Seller) may be referred to herein as a “candidate” or a “candidate entity.” It will be appreciated that, with respect to candidate entities in the context of a sourcing platform as set forth below, the terms “connect,” “match,” “pair,” “correlate,” “assign,” and other similar terms (and their derivatives) are intended to be interpreted broadly to encompass identifying a Buyer and a Seller having consistent goals such that a commercial transaction between the two will or may be mutually beneficial. In that sense, “matching” a Buyer and a Seller having consistent goals may involving identifying a pair of candidate entities (e.g., one Buyer and one Seller) based, at least to an extent, upon a degree of such consistency, which may be computed or derived based upon or as a function of, for example, a predetermined or dynamically adjusted criterion or a set of criteria; historical data, instantaneous or current demands or other extenuating circumstances, urgency or other timing considerations, differences in bid and ask price or quantities, or a combination of these and a variety of other factors such as may be analyzed or evaluated in connection with cross-correlation matrices, matching or difference engines, or other metrology tools may be useful for this purpose. The disclosed subject matter is not limited to identifying a single Buyer and a single Seller for a particular transaction, however, and so the terms matching, connecting, pairing, associating, etc. in this context also contemplate situations in which a single Buyer’s needs may be satisfied by multiple Sellers, or all or a portion of a single Seller’s inventory may be distributed to more than one Buyer; multiple Buyers and multiple Sellers may also be parties to a single matching, pairing, connecting, or associating operation as will be appreciated from the following detailed description. In that regard, the disclosed sourcing system and method may connect or match candidate entities in an optimized manner in light of present or expected needs of myriad parties, timing considerations for one or multiple transactions, transaction histories between and amongst the candidates, maximizing (or minimizing) monetary exposure, and the like.

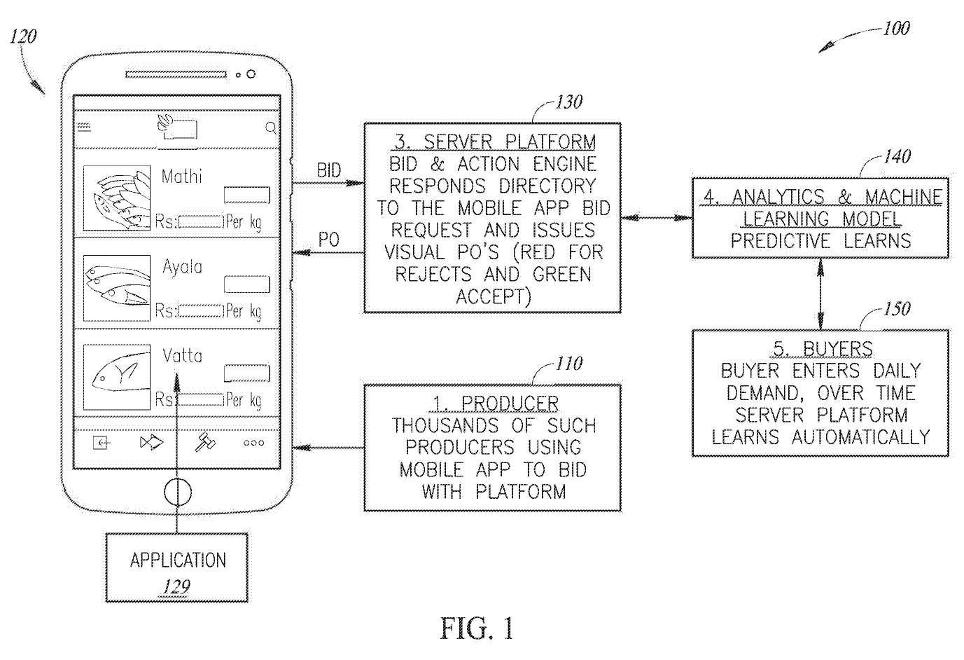

In operation, a system and method of sourcing materials may employ a machine learning powered technology platform (see, e.g., FIG. 1) that automatically predicts supply and demand for all participating candidate entities, for instance, based upon contemporaneous data as well as analytics, metrology tools, and evaluation of historical data. In some implementations, the platform may automatically learn (e.g., based in part upon the foregoing analytical data processing) new trends that may affect or otherwise influence (on the part of one or more Buyers) the quantities sought to be sourced, desired price points, transit time requirements, and the like, and may disseminate such projected Buyer demand information directly to a large number of Producers which might otherwise be associated with an unorganized segment that sells in local markets to intermediaries.

In accordance with the present system and method of sourcing materials, neither human interaction nor decision-making need be involved at the time the transaction is consummated; the disclosed platform may automatically manage the sourcing process, matching Buyers’ demands with Sellers’ capabilities. In this manner, a sourcing platform may facilitate Buyers achieving the lowest cost and highest quality by directly sourcing from Producers based, in part, upon offers submitted electronically by the Producers themselves (thus ensuring that a particular transaction or series of transactions will be satisfactory for the participating Producers).

In some embodiments, access to the platform may be effectuated through a website address or uniform resource locator (“URL”), for instance, such that the platform’s functionality may be utilized in connection with a standard or generic browser application installed on any device with Internet access. Additionally or alternatively, a software application (or “app”) may be provided to facilitate interaction with the platform. For example, a mobile app may be downloaded and installed on a hand-held, mobile, portable, or other wireless device such as a wireless telephone, a laptop or tablet computer, or other portable apparatus; in another example, such a software application may be installed on a desktop computer, workstation, networked terminal device, or any other digital processing apparatus capable of bi-directional data communication with the platform as set forth below. In operation, such a browser implementation or software application may allow the Producers or other candidate entities to interact with the platform as set forth below. In the case of Producers or Sellers, such candidate entities may employ the browser interface or software application to submit a bid to the platform wherein the bid provides an indication of s particular candidate’s willingness or commitment to supply a particular quantity of goods or perishable food items at a particular price. On the other side of a transaction, one or more Buyers may employ the browser interface or software application to browse bids, enter queries, make counter offers, accept bids, and the like.

In the case of candidate entities that are not especially facile with computer technologies and network-based platforms, in may be desirable that a user interface (“UI”) or user experience (“UX”) presented by the software application be simply and “user-friendly.” In that regard, the UX/UI may be operative to provide scrolling images of products of interest and to provide easily understood bidding interactions with the platform. For example, the platform may be operative to provide very simple responses to user interactions, such as with a green icon, tick box, or radio button indicating that the transaction will for proceed, and a red icon, tick box, or radio button indicating that a Buyer will not be buying a particular product that is offered. In some embodiments, the candidate entities’ interactions with the platform, via the software application or website interface, for instance, may have the effect of creating a virtual purchase order (“PO”) memorializing a transaction agreed upon between two or more candidate entities.

In some embodiments, end-to-end analytics and data evaluation processes may allow an administrator to fine-tune or otherwise selectively to adjust cost, quantity, quality, distance to Buyer, estimated time of transit between dispatch at a Seller’s facility and arrival at a Buyer’s facility, and other transactional parameters to assist a machine learning engine or other analytical tools with respect to historical data, saving candidate entities’ preferences, logging, flagging, or otherwise identifying successful or unsatisfactory transactions, and the like. Such an administrator may be associated with, employed by, or otherwise affiliated with either a platform operator, on the one hand, or one of the candidate entities, on the other hand; in some instances, it may be desirable to allow the foregoing administrative tasks to occur without involving or apprising respective candidate entities potentially involved in a transaction, though it may be desirable that a platform administrator be apprised of a particular candidate entity’s preference information, for example, to assist with machine learning and predictive analytics performance or otherwise to facilitate future transactions involving a particular candidate entity.

FIG. 1 illustrates a materials sourcing platform in accordance with aspects of the disclosed subject matter. As indicated in FIG. 1, a system 100 (for example, an “Electronic Commodities Platform”) may generally comprise one or more Seller candidate entities (“Sellers 110”) each of which may interact with a software application 129 installed on or accessible by a remote device 120 that is capable of engaging in bi-directional data communication with a server platform 130, for example, via a network (not illustrated in FIG. 1) such as a local area network (“LAN”), a wide area network (“WAN”), the Internet, an Ethernet, or some other cellular, satellite, or digital communications network capable of transmitting data between and amongst entities, devices, apparatus, or systems. Server platform 130 may also be communicatively coupled (i.e., capable of engaging in bi-directional data communication) with one or more Buyer candidate entities 150 (“Buyers”) via a network infrastructure (also not shown in FIG. 1) that has similar capabilities.

It is noted that the present disclosure is not intended to be limited by the particular hardware infrastructure, network topology, or communications protocols facilitating communicative coupling between Seller devices 120 and server platform 130, on the one hand, or between server platform 130 and devices (not shown in FIG. 1) owned, operated, or accessible to Buyers 150, on the other hand. It is also noted that the foregoing networking technologies employed by server platform 130 to communicate with the various candidate entities may not be identical or even similar; system 100 may be enabled and have utility so long as server platform 130 is communicatively coupled both to remote device 120 as well as to a similar or analogous device associated with Buyers 150. An ordinarily skilled artisan will readily appreciate that this may be effectuated by or in cooperation with any of various networking technologies generally known in the art or developed and operative in accordance with known principles.

As noted above, block 110 is intended to represent one or more Seller candidate entities (“Sellers” or “Producers”), each of which owns, operates, or has access to a remote device 120. While the following discussion refers to Sellers 110 in the plural case, it should be appreciated that the singular case is also appropriate and within the scope and contemplation of the present disclosure. Sellers 110 may comprise or represent a fragmented or disparate set of fishermen, farmers, or other purveyors of perishable goods; Sellers 110 may (currently or historically) sell or have sold to intermediaries in local markets for a lower price (per unit, volume, or quantity) than might potentially be realized in the case where Sellers 100 were, instead, selling directly to those with current or expect need (such as Buyers 150, for example).

In the context of procurement of fish In India, for example, one estimate suggests that over 5,000 coastal fishing grounds exist, employing over 14 million fishermen and fishery-allied professionals (see, e.g., Indian Fisheries Handbook of 2014 published by the Indian government); similar levels of fragmentation are also seen in markets for vegetables and meat, both in India and elsewhere. Given such levels of fragmentation, and the vast number of possible commercial contacts or agents representing these various fragmented industries, a people-intensive supply chain requisition strategy may be inefficient, ineffective, or cost-prohibitive. Accordingly, it is believed that server platform 130 cooperating with a mobile app or other suitable software application 129 may facilitate aggregation of information regarding production capabilities and selling preferences for such fishermen, farmers, and other purveyors of perishable goods or edibles.

As noted above, remote device 120 may be embodied in or comprise a hand-held, mobile, portable, or other wireless device such as a wireless telephone, a laptop or tablet computer, or other portable apparatus; alternatively, in an embodiment in which mobility or wireless access may be foregone, remote device 120 may be implemented in the form of a desktop computer, workstation, hard-wired networked terminal device, or any other fixed or non-portable digital processing apparatus. The design, construction, and operation of the various functional blocks, hardware components, and operational characteristics of remote device 120 are conventional and generally well-known. As a result, design, construction, operational, and functional details of remote device 120 are not described in further detail herein, as they will be understood by those skilled in the relevant art. It is noted, however, that Buyers 150 may access server platform 130 using a remote device (either wireless or wired) that is similar or analogous remote device 120; hardware, functionality, and operational capabilities of such devices employed by Buyers 150 are similarly conventional.

Software application 129 may be embodied in or comprise computer-readable executable code or instruction sets, instruction or functional modules, data libraries, dynamic-linked libraries, or other information to be executed, implemented, or otherwise manipulated by hardware, firmware, or both, associated with remote device 120 (or an analogous device used by Buyers 150). In some embodiments, software application 129 may be a simple to use (i.e., “user-friendly”) mobile or other app that may be installed in mobile telephones or wired computer systems (such as remote devices 120) owned or operated by Sellers 110. In India, for example, the penetration of data-enabled wireless communication devices (e.g., “smart phones,” tablet computers, or other hand-held wireless computing devices) is very high, and a sizeable proportion of the population owns (or has access to) a smart phone or hand-held device. In addition, social media and mobile app usage is very common, and thus Sellers 110 in India who might otherwise not be especially facile with computers or networked technologies are nevertheless very familiar with mobile app usage.

System 100 provides Sellers 110 in very complex and fragmented markets and industries a very simple software application 129 that, as is typical with mobile apps, may allow intuitive and familiar scrolling functionality (e.g., up and down a list or menu that is too long to be displayed on a screen, for instance), selecting (e.g., by clicking or tapping) a photo, icon, tradename, product identifier, barcode, quick response (“QR”) code, or some other representation of a product, and entering (e.g., via text box, drop-down menu, or some other familiar UI input mechanism) transaction particulars, such as a total available quantity, a price per unit or volume, availability date, shipping or carrier information, liability terms, etc. that are or may be relevant to Buyers 150. These data, a subset of these data, or a combination of these or other data may be entered via a UI of software application 129 to device 120, which in turn may transmit, distribute, send, or otherwise communicate such data, either as a discrete package or in combination with other data (such as an identification of Seller 110, address or city information, value-added tax eligibility or other taxation information, carriage terms, etc.), to server platform 130. In FIG. 1, this is represented by the one-way arrow from remote device 120 to server platform labeled as a “Bid.”

In the foregoing manner, software application 129 may allow Seller 110 to interact with remote device 120 to construct a Bid (or “offer”) to sell goods, perishables, or other merchandise on the open market and to transmit that Bid to server platform 130. Once the Bid is placed, or delivered to server platform 130 by remote device 120, for example, then server platform 130 may automatically compare the Bid against other Bids received by server platform 130 (either from the same or other Sellers 110). In that regard, server platform 130 may employ a sophisticated machine learning algorithm or other control or processing logic that takes into consideration, for example, historic price learning (for instance, from previous transactions involving the same or similar products and quantities, the same or similarly-situated Sellers 110, or both), price analytics (based, for instance, upon current or past supply/demand curves, currently pending or historical transactions involving similar products and Sellers 110, and the like), relative distances between Seller 110 and one or more candidate Buyers 150, quantities and estimated quality of product available from the Seller 110 or the universe of other candidate Sellers 110 (or a subset thereof) that may or may not be located closer to a candidate Buyer 150, commercial considerations (such as those set forth above), or a combination of these and a variety of other transactional parameters that are currently relevant or expected to be relevant to current or prospective Buyers 150. In FIG. 1, this analytical functionality is represented by Analytics and Machine Learning Engine (“AMLE”) at reference numeral 140. AMLE 140 functionality is addressed in more detail below, but it is worth noting here that AMLE 140 need not be a separate device or system component distinct from server platform 130 as illustrated in FIG. 1; for example, in some implementations, it may be desirable to integrate or otherwise to combine AMLE 140 hardware or functional characteristics into server platform 130, either as a physical component of server platform 130 or as a virtual processing element executed by or in cooperation with one or more hardware components resident at or deployed by server platform 130.

As indicated in FIG. 1, Buyers 150 may also be communicatively coupled to server platform 130 and have access to AMLE 140. Accordingly, AMLE 140 may receive data or other information from Buyers 150 related to demand for a particular product or category of products. Such demand data or information may include specific products (e.g., identified by SKU numbers), families or categories of products (e.g., identified by product type, function, or characteristics), quantities sought (e.g., either currently or on an on-going basis), purchase prices or price ranges (which may be quantity-dependent) that may be acceptable to a particular Buyer 150, location information related to a particular facility owned or operated by a particular Buyer 150 (including, for instance, access to rail lines, ports of entry, airports, etc.), and a variety of other data that may be relevant or necessary to consummate an electronic transaction for purchase of products from one or more Sellers 110.

In that regard, each respective Buyer 150 may be equipped with or have access to a remote device capable of executing or accessing a software application to enable transmission of the foregoing transaction parameters to server platform 130 and to receive notifications, information, and other data (such as transaction details and confirmations) from server platform 130 in cooperation with AMLE 140, as indicated by the bi-directional arrows on the right side of FIG. 1. As noted above, these functional elements may be similar or analogous to remote device 120 and software application 129 described above with reference to Sellers 110; details need not be repeated here, and these components of system 100 have been omitted from FIG. 1, for the sake of clarity and because those of skill in the art will appreciate how to implement a software application on the buy-side in the FIG. 1 embodiment without undue experimentation.

In some implementations, server platform 130 and AMLE 140 may be proprietary to a single Buyer 150. Specifically, system 100 may be employed for the exclusive benefit of one Buyer 150 seeking to make its supply chain more efficient and to minimize effort associated with sourcing from a multiplicity of Sellers 110. Where system 100 is so deployed (e.g., in an internal procurement context), one specific Buyer 150 may retain sole and exclusive ownership or control of server platform 130 and AMLE 140, though a plurality of Sellers 110 (with access to appropriate software applications 129) may also benefit from operation of system 100 by submitting competing Bids as described above. In an alternative implementation, system 100 in general, and server platform 130 in particular, may be open to multiple third-party private or institutional Buyers 150 (each of which may have access to appropriate software applications). In this context, an owner or operator of server platform 130 may not technically act as an intermediary as described above, but rather serve to facilitate brokering or matching parties’ respective requirements in complex transactions across multiple candidate entities on both the buy-side and the sell-side.

In either event, during operation of system 100, Buyers 150 may generally provide historic or recurrent demand data and other relevant transactional information (such as described above) in electronic format to seed the analytics engine resident at or accessible by AMLE 140. In some implementations, Buyers 150 may also alter or modify such demand data and other relevant information. It will be appreciated that AMLE 140, responsive to such data provided by Buyers 150, may automatically determine purchase quantities and optimum or favorable purchase prices (e.g., as a function of quantities) taking into consideration a variety of factors and match or assign the needs of one or more Buyers 150 with the products and quantities offered by one or more Sellers 110. For example, some such factors may include, but are not limited to: quantities and purchase prices of transactions occurring on the same day of the week during the previous week (or during one or more prior months); transaction parameters associated with purchases occurring on the immediately preceding day (or during some other relevant or desired time period); quantities and purchase prices of transactions recently consummated between the same parties; other historic data; seasonal or environmental factors; order book projections for a specific time period; and other transaction-relevant information. For example, where stone crab season is approaching its peak, it may be expected that the price per pound for stone crab legs may steadily decrease in the coming weeks. In the event of an approaching hurricane or a contemporaneous oil spill near prime fishing grounds, for example, a Buyer 150 may expect the market price for stone crab legs to spike higher, irrespective of the date on the calendar; under these circumstances, such an informed Buyer 150 may opt to buy more of a perishable product immediately, rather than to wait for a price decrease that may never affect the market during the relevant time period. These and other types of considerations may affect the data provided by Buyers 150 to server platform 130 substantially as set forth above, and may be employed by AMLE 140 in determining how to match the specific requirements of a particular Buyer 150 with the myriad Bids provided by Sellers 110.

Following desired or appropriate analytical evaluation, server platform 130 may make a determination whether to match a Seller 110 with one or more Buyers 150; responsive to such a determination, server platform 130 may provide an indication that a match has been successful or that AMLE 140 failed successfully to identify a suitable Buyer 150 for a particular transaction represented by the Bid. In the former case, server platform 130 may provide a PO (as indicated by the one-way arrow labeled “PO”) along with a positive indication that the Bid has been satisfied; such a positive indication may be represented by a UI of software application 129 as a “Green Light,” “Thumbs Up,” “Smiley Face,” or some other familiar and readily recognizable positive icon or descriptor. Conversely, in the latter case in which a match could not be made, server platform 130 may provide a negative message indicative of a failed transaction; such a negative indication may be represented by a UI of software application 129 as a “Red Light,” “Thumbs Down,” “Frowning Face,” or some other familiar and readily recognizable negative icon or descriptor. In one embodiment, if a UI of software application 129 provides a green light or other positive indicator, Seller 110 is apprised that one or more Buyers 150 have been matched to the Bid originally submitted to server platform 130.

It will be understood that server platform 130 together with AMLE 140 represent much of the utility of system 100 (and its attendant methodology) of sourcing materials as set forth herein. Specifically, server platform 130 may receive thousands of Bids from candidate Sellers 110, and may employ sophisticated algorithmic functionality provided by AMLE 140 to match relevant needs of candidate Buyers 150 with goods or products available from one or more suitable candidate Sellers 110, thereby taking advantage of technology in sourcing applications that has heretofore been under-utilized. As noted above, the algorithmic approach may utilize or otherwise be influenced by a number of variables such as, for example: Bid price; current and/or historical pricing for similar Bids of similar quantities for similar or related products; commission structure or other administrative costs attendant with the Bid; transport, shipping, carriage, or insurance costs from Seller’s 110 to Buyers’ 150 respective facilities; seasonal, historical, or exigent demand or supply variability; requirements necessitated by or requested by Buyer 150 (such as air freight as opposed to rail, refrigeration demands, rush orders, etc.); or a combination of these and other factors. In operation over time, AMLE 140 may employ techniques generally known in the art or developed and operative in accordance with known principles to supply predictive analytics to the process of evaluating and actioning of Bids.

Specifically, AMLE 140 may leverage historic trends as a useful source of information from which predictions may be made – both in terms of determining what kind of product may be in demand (and when) as well as in terms of determining whether a particular Bid is suitably or appropriately matching with the requirements of one or more Buyers 150. In some implementations, AMLE 140 which, as noted above, may be communicatively coupled to or incorporated into server platform 130, may accomplish these goals in the following manner.

Initially, AMLE 140 may examine historical data – and in particular, manual procurement and purchase data with respect to Buyers 150 – to predict patterns with respect to specific goods or products, the purchase of which may increase profitability (for an operator of server platform 130, for example) or affect demand (on behalf of Buyers 150, for example); additionally or alternatively, such patterns may inform purchasers (such as Buyers 150, for instance, or an operator of server platform 130 in the event that such an operator is effectively acting as an intermediary) regarding necessary or desirable quantities or volumes of such products to procure from one or more Sellers 110 at any particular instant in time. Especially in the case of Buyers 150 that typically buy a large number or variety of products, the foregoing analysis is difficult to perform manually without the benefit of a high throughput machine learning module and also a deep analytics module – in the absence of AMLE 140, for example, it is certainly not possible to conduct such an analysis quickly enough to be useful for the candidate entities. Once AMLE 140 determines requisite or desired product quantities, qualities, and other parameters sought by the universe (or a subset) of Buyers 150, this information may be provided (e.g., via software application 129) to interested or relevant Sellers 110. As with many markets, quantities of products Bid may be a function of price, or vice versa. In one embodiments, for example, in order to arrive at an optimum price for all interested parties, AMLE 140 may generally provide relevant Bid information to Buyers 150 and suggest as follows: if the price per unit is $200, then buy 100kg, but if price is $190 then buy 1000 kg; or something similar. Those of skill in the art will appreciate that many different scenarios may lead to varying suggestions, either as a function of parameters considered by AMLE 140, global constraints placed on the analytics engine, custom constraints or preferences of Sellers 110 or Buyers 150, algorithm or analytics tools design choices, or a combination of some or all of these factors. In any event, some implementations such as the above example may incentivize Sellers 110 to reduce prices to attract the most Buyers 150 and to increase the probability of AMLE 140 determining a match or assignment for the original Bid.

Additionally, AMLE 140 may also assist in deciphering and validating or authenticating Bid data that are received from thousands of such candidate entities providing Bids. Given that server platform 130 may be communicatively coupled to a vast number of Sellers 110, one role of AMLE 140, either individually or in cooperation with other components of server platform 130, is to prevent fraud. In operation, and having collected Bid data over time, AMLE 140 may log or store typical price ranges for particular products, quantities, and other Bid parameters related to a variety of past and pending deals. By comparing material terms and relevant parameters of newly received Bids with such historic data maintained and associated with past or pending Bids, AMLE 140 may be enabled to identify (and possibly to reject or return for amendment) any fraudulent or mistaken Bids. Additionally, AMLE 140 may determine a priority order to use for pending Bids (e.g., which Bid should be used as a starting point or primary data point for analyzing a complicated transaction involving multiple Buyers 150 and Sellers 110) and how to allocate total demand from Buyers 150 across multiple Bids from Sellers 110. In some implementations, this functionality for AMLE 140 may be more important than in others, for example, because different Bids may be received from disparate Sellers 110 a different times. In some embodiments, demand may be split or apportioned in such a manner that some portion (which may be predetermined or dynamically adjusted by AMLE 140 as a function of real-time or near real-time factors) of available supply is provided by the Seller 110 with the lowest Bid price at a particular point in the time; in such an embodiment, over a period of time, overall steady state demand may be distributed across Bids provided by multiple Sellers 110, which tends to lead to a price that is optimized for steady state market conditions. AMLE 140 may be responsible for suitable calculations involving current and historic data to achieve these goals in accordance with known machine learning and predictive analytics techniques.

In the case of many perishables (e.g., fresh fish or other seafood items), market price is typically a function of demand and supply. In this analysis, demand is usually the more consistent variable since, conventionally, the same intermediaries are responsible for buying predetermined quantities from Producers. In the case of farmed or fished products, on the other hand, supply is typically more unpredictable – products from nature are prone to many variables and environmental factors that are beyond farmers’ and fishermen’s control. This is particularly true in areas where modern commercial farming tools are not (or are rarely) used and where modern refrigeration technologies are (or may be) underutilized. In such markets, a sudden or unexpected spike in supply may result in a deficiency of ready and willing purchasers, which may lead to a “distress sale” characterized by unusually low asking prices. In some embodiments, AMLE 140 may employ predictive analyses and machine learning techniques to detect such distress spikes, and may dynamically redraw relevant demand curves based upon the nature of the received Bids (from Sellers 110) and the demand data (from Buyers 150) to match candidate entities’ requirements despite market conditions that create distress. Sellers 110 may dispose of distressed materials or other perishables and Buyers 150 may benefit from reduced prices that remain satisfactory for Sellers 110.

In accordance with the foregoing, it will be appreciated that Sellers 110 participating in system 100 may enjoy higher price markups than they otherwise might have achieved in their respective local markets, and Buyers 150 may benefit from efficient sourcing without having to resort to contacting multiple Sellers 110 directly or paying a premium (and tolerating the attendant delays and quality reductions) associated with using an intermediary. In that regard, Buyers 150 may benefit from reduced prices and increased quality, since the sourcing is direct from Sellers 110.

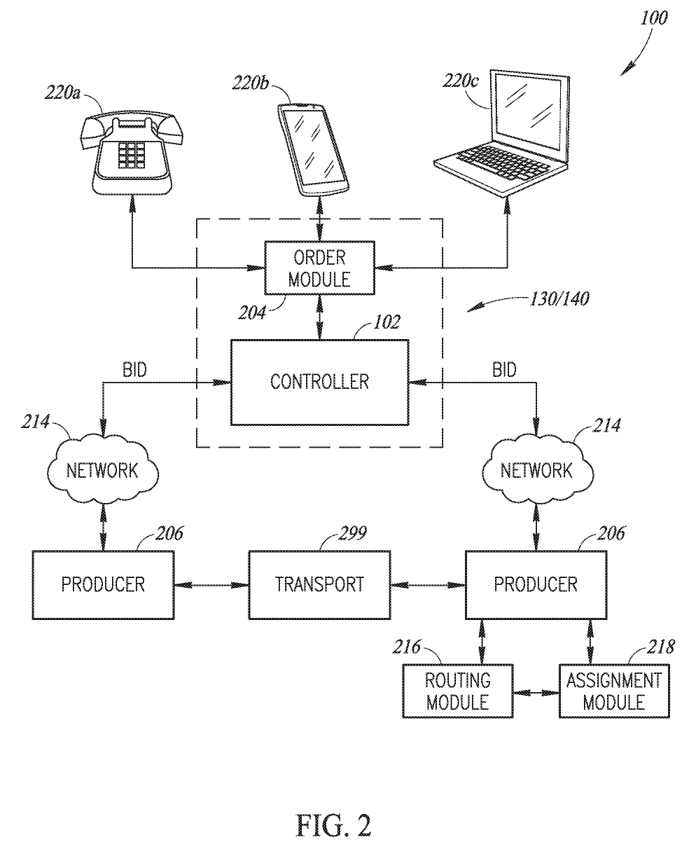

FIG. 2 illustrates a materials sourcing environment that includes a central controller communicably coupled to predictive analytics and sourcing engines, according to one illustrated embodiment. Specifically, FIG. 2 is similar to FIG. 1, but provides additional detail as to some of the components of system 100. In the illustrated implementation, system 100 generally comprises a controller 202, an order module 204, and one or more Producer modules 206 communicably coupled to controller 202 via one or more networks 214. A routing module 216 and an assignment module 218 are shown communicably coupled to each other and to one Producer module 206 (other Producer modules 206 may also include these components, though they have been omitted elsewhere in FIG. 2 for clarity). Although illustrated as discrete components, some or all of the functions performed by order module 204 and controller 202 may be shared between these components or combined or integrated into a single component or hardware architecture; this was noted above with reference to server platform 130 and AMLE 140, the integration of which is represented diagrammatically by the dashed box in FIG. 2 labeled with reference numeral 130/140. For example, controller 202 may perform various order entry or identification functions rather than relegating these functions to a dedicated order module 204. As another example, order module 204 (rather than controller 202, for instance) may include some of the functionality of AMLE 140, depending upon hardware implementation and configuration of server platform 130, processing bandwidth of the various components, memory access or controllers associated with distributed memory paradigms, or a variety of other factors. Similarly, the functionality of Producer module 206, assignment module 218, and routing module 216 may be shared between or combined amongst the components as is generally known in the art.

In operation, server platform 130/140, in general, and controller 202, in particular, may receive Bids from one or more Producer modules 206 that are owned, operated by, or accessible to Producers. In that regard, Producer modules 206 may be embodied in or comprise remote devices 120 having software applications 129 as described above, or may have such hardware and software functionality readily accessible, and may communicate Bids substantially as set forth above. In addition to software application 129, Producer module 206 may include or have communicative access to routing module 216 and assignment module 218, which, as noted above, may be communicably coupled to each other. Upon successful matching (e.g., by AMLE 140 at server platform 130) of a Bid or a portion of a Bid with a Buyer’s necessity, controller 202 may communicate (via network 214) particulars of a PO or data representative of a PO to Producer module 206, which in turn may employ software and hardware resources at assignment module 218 to assign inventory, or a portion thereof, to a particular Buyer based upon an applicable PO; similarly, responsive to or otherwise based upon output from assignment module 218, routing module 216 may, either independently or in cooperation with other resources at Producer module 206, route inventory to an appropriate shipping or transportation resource (such as a shipping or train line, an air freight operation, or other commercial transportation carrier).

Controller 202 may include one or more systems or devices used to coordinate the receipt or generation bids from Producers as described above with reference to FIG. 1. In at least some instances, order module 204 may receive orders placed by one or more Buyers using any of a variety of sources or communications technologies. In some instances, order module 204 may include a telephonic interface to enable bi-directional communications with conventional or voice over Internet Protocol (VoIP) telephonic equipment 220a. Such telephonic interfaces may be in the form of automated or semi-automated interfaces in accordance with which a Buyer may provide data by entering a defined key sequence corresponding to a desired food product, perishable item, or other goods, a destination address, a desired date or time of delivery, etc. Some telephonic interfaces may include an attendant-operated interface in accordance with which a Buyer may place a verbal order with an attendant or customer representative who then manually enters data corresponding to a desired product, a destination address, a delivery date or time, etc. into controller 202, for example, using a touchscreen, a keyboard or pad, or other entry device. In some instances, order module 204 may include a network interface, for example, a network interface communicably coupled to the Internet, over which orders may be placed via smartphone or other portable or wireless device 220b, or via any other type of wired or wireless computing device 220c. In such instances, order information corresponding to a desired product or item, a destination address, a requested delivery date, and the like may be provided by a Buyer in a format requiring minimal or no reformatting by order module 204 prior to providing data or other information representative of an order to controller 202.

In various implementations, in addition to receiving Buyer orders via telephone 220a, smartphone or tablet 220b, or computer 220c, controller 202 may do more than simply aggregate received orders. For example, controller 202 may include one or more machine learning or similar algorithms useful for predicting the demand for certain food items, perishables, or other goods to be sourced as set forth above with reference to FIG. 1. For example, controller 202 may include one or more machine learning algorithms able to correlate or otherwise logically associate the ordering of a number of particular items (e.g., stone crab legs) in a constrained geographic area (e.g., a city or restaurant district within a city) over the course of a defined temporal period (e.g., weekly during stone crab season) or during one or more defined events. In such instances, controller 202 may autonomously generate anticipated demand curves or data representative of predicted demand (on the part of one or more Buyers) that may be used, individually or in combination, with Bids provided by one or more Producers to match or associate current or predicted demand with current or predicted supply substantially as set forth above. In that regard, AMLE 140 functionality may be employed or accessed by controller 202 for this purpose.

In at least some instances, controller 202 may provide a Buyer placing an order for an item with an estimated delivery date or time for the item. In at least some instances, the estimated delivery time may be based on the time to assign (e.g., at assignment module 218) a desired or necessary quantity and to prepare and to route (e.g., at routing module 216) a particular shipment at a particular Producer’s Producer module 206. Such estimated delivery times may take into account factors such as the complexity of preparation of items (such as fragmenting large volumes into smaller, discrete shipments), necessary packaging operations necessitated by such fragmentation, dispatch for transportation, carrier preferences or requirements and attendant delays, customs administration (in the case of international shipments), and the like. In other instances, an estimated delivery time may reflect availability of items that have been pre-staged in a particular area and are (at the time of receipt of an order) currently prepared for shipment in accordance with a Producer’s original Bid.

Controller 202 may schedule preparation and shipment of items in accordance with received or generated orders, either individually or in cooperation with assignment module 218, routing module 216, or data or information received from one or both. In some instances, controller 202 may be collocated with or integrated with AMLE 140. This is the case in the implementation illustrated in FIG. 2, as the functionality of AMLE 140 described above is integrated with controller 202 and order module 204 at platform 130/140. In that regard, controller 202 may match or assign Bids to one or more Buyers as set forth above, and communicate one or more appropriate POs (or data representative of same) indicative of a suitable match to an appropriate Producer module 206. Responsive to receipt of one or more outputs provided by controller 202, items may be prepared or assembled for shipment based upon operation of assignment module 218 and routing module 216. In at least some instances, a Producer module 206 may autonomously perform the preparation at least a portion of the products, for instance, at the direction of controller 202. For example, a quantity or portion of a particular Producer’s inventory may be separated and prepared for shipment to one Buyer, while another quantity or portion may be separated and prepared for shipment to a different Buyer; this may be based upon order data received from the respective Buyers (at order module 204), the Producer’s original bid (received via network 214 by controller 202), and operation of AMLE 140 at or in cooperation with controller 202. Each of the prepared or assembled shipments allocated by assignment module 218 (that assigns or matches products to a Buyer based upon results from AMLE 140) and routing module 216 (that routes or ships particular shipments to a proper Buyer based upon results from assignment module 218) can then be loaded or otherwise placed into the stream of commerce based upon shipping preferences and the matching identified by AMLE 140. Routing module 216 may route inventory to a transportation carrier 299 as indicated in FIG. 2 for shipment.

In the implementation illustrated in FIG. 2, system 100 may reduce the time required for matching or connecting Buyers having necessity and Producers having inventory. For example, by employing AMLE 140 to match Producers’ inventory (as represented by one or more Bids) with order parameters, system 100 may allocate inventory across multiple Buyers and route applicable orders (items, volumes, shipping requirements, etc.) to transportation carrier 299 with minimal delay and without resort to intermediaries.

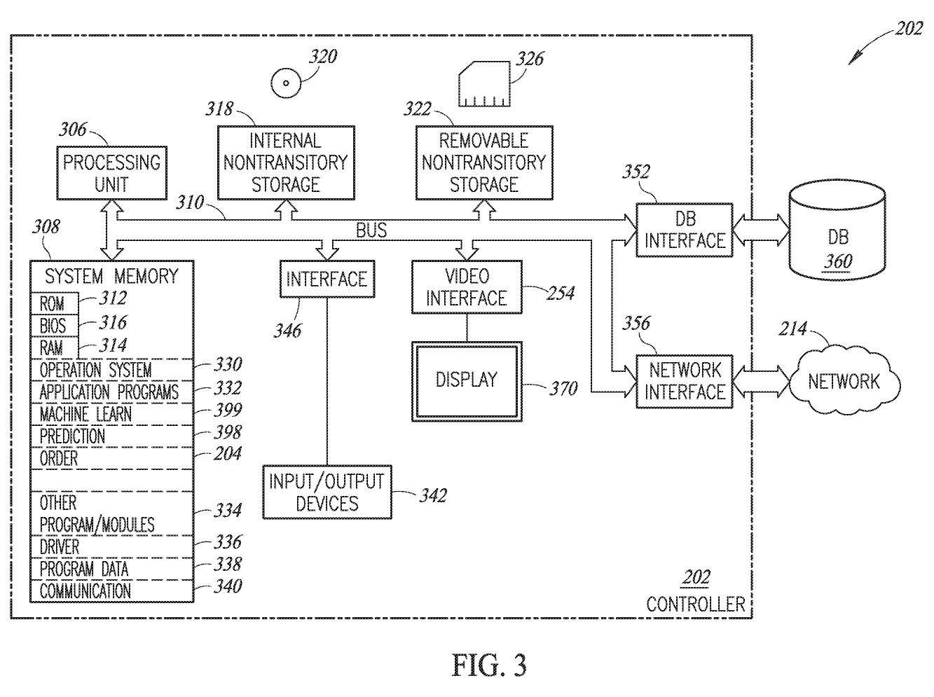

FIG. 3 shows a materials sourcing system controller, according to one or more illustrated implementations. The representation in FIG. 3 and the following discussion provide a brief, general description of an exemplary controller 202 that may be used to provide the functionality described above. Although the order module 204, the machine learning module 399, and the prediction module 398 are described herein as functional elements of controller 202, one of ordinary skill in the art would readily appreciate that some or all of the functionality of these and other components in FIG. 3 may be performed using one or more additional computing devices which may be external to and accessible by controller 202. For example, order module 204 may be disposed in a national or regional call or order aggregation center that is remote from the controller 202, or order module may be collocated with, but implemented independently of, controller 202 as represented in FIG. 2. In another example, though illustrated as integral with system memory 308, it will be appreciated that machine learning module 399, prediction module 398, or both may be implemented on hardware and firmware that is distinct from the hardware and firmware that are used to provide the bulk of functionality of controller 202. It is noted that controller 202 may implement some or all of the various functions and operations discussed immediately above in reference to FIGS. 1 and 2.

Although not required, some portion of the implementations or embodiments will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including handheld devices (for instance web or Internet enabled satellite or cellular telephones, tablet computers, or PDAs), multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be stored in both local and remote memory storage devices and executed using one or more local or remote processors, microprocessors, digital signal processors, controllers, or combinations thereof.

In some implementations, controller 202 may be embodied in or comprise any current or future-developed computing or data processing system capable of executing one or more instruction sets. Controller 202 may generally include a processing unit 306, a system memory 308 and a system bus 310 that communicably couples various system components including system memory 308 and processing unit 306. Controller 202 may at times be referred to in the singular herein, but this is not intended to limit the implementations or embodiments to a single system, since in certain embodiments, there will be more than one system or other networked computing device involved. Non-limiting examples of commercially available systems suitable for controller 202 include, but are not limited to, an Atom, Pentium, or 80x86 architecture microprocessor as offered by Intel Corporation, a Snapdragon processor as offered by Qualcomm, Inc., a PowerPC microprocessor as offered by IBM, a Sparc microprocessor as offered by Sun Microsystems, Inc., a PA-RISC series microprocessor as offered by Hewlett-Packard Company, an A6 or A8 series processor as offered by Apple Inc., or a 68xxx series microprocessor as offered by Motorola Corporation.

Processing unit 306 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 3 are of conventional design. As a result, such blocks need not be described in further detail herein, as they will be understood by those skilled in the relevant art.

System bus 310 may employ any known bus structures or architectures, including a memory bus with a memory controller, a peripheral bus, and a local bus. System memory 308 generally includes read-only memory (“ROM”) 312 and random access memory (“RAM”) 314. A basic input/output system (“BIOS”) 316, which may form part of or have access to ROM 312, may contain basic routines that help transfer information between elements within controller 202, such as during start-up, as it generally known. Though only a single bus 310 is illustrated in FIG. 3, it will be appreciated that some implementations or embodiments may employ separate buses for data, instructions, and power as a design choice, as a function of the operational characteristics of other components of controller 202, or both.

Controller 202 may include one or more internal nontransitory storage systems 318. Such internal nontransitory storage systems 318 may include, but are not limited to, any current or future-developed persistent storage device 320. Such persistent storage devices 320 may include, without limitation, magnetic storage devices such as hard disc drives, electromagnetic storage devices such as memristors, molecular storage devices, quantum storage devices, electrostatic storage devices such as solid state drives, and the like.

Controller 202 may also include one or more optional removable nontransitory storage systems 322. Such removable nontransitory storage systems 322 may include, but are not limited to, any current or future developed removable persistent storage device 326. Such removable persistent storage devices 326 may include, without limitation, magnetic storage devices, electromagnetic storage devices such as memristors, molecular storage devices, quantum storage devices, and electrostatic storage devices such as secure digital (“SD”) drives, USB drives, memory sticks, or the like.

As indicated in the drawing figure, internal nontransitory storage systems 318 and optional removable nontransitory storage systems 322 may communicate with processing unit 306 via system bus 310. In that regard, these components may include interfaces or device controllers (not shown) communicably coupled to system bus 310, as is known by those skilled in the relevant art. Nontransitory storage systems 318, 322, and their associated storage devices 320, 326, respectively, may provide nonvolatile storage of computer-readable instructions, data structures, program modules, and other data for controller 202 and the various constituent components. Those skilled in the relevant art will appreciate that other types of storage devices may be employed to store digital data accessible by a computer, such as magnetic cassettes, flash memory cards, Bernoulli cartridges, RAMs, ROMs, smart cards, etc.

Program modules may be stored in system memory 308, such as an operating system 330, one or more application programs 332 (which may include software application 129, for instance), other programs or modules 334, drivers 336 and program data 338. Additionally or alternative, some such program modules may be implemented in hardware, firmware, or a combination of both such that they are not resident in, but may be accessible by, system memory 308.

Application programs 332 may include, for example, one or more machine executable instruction sets capable of providing an order module 204, software application 129, or a combination of these and other applications. As noted above, order module 204 may receive order data or other information from one or more candidate Buyers, including identification of a product, desired quantity, shipping preferences or requirements, and other data or information necessary to effectuate an electronic transaction for the purchase of goods. Similarly, software application 129 may receive corresponding or counterpart information provided by a Producer or Seller. These data, either independently or in combination with other information received by controller 202, may be used to connect or otherwise to match one or more candidate Buyers’ necessity with one or more candidate Sellers’ inventory is currently or expected to be the subject of a Bid.

System memory 308 may also include other programs/modules 334, such as including logic for calibrating and/or otherwise training various aspects of the controller 202. Such other programs/modules 334 may additionally include various other logic for performing various other operations and/or tasks.

System memory 308 may also include any number of communications hardware, networking interface components, and/or software programs 340 to permit controller 202 to access and exchange data with other systems or components, such as with routing modules 216, assignment modules 218, communications interfaces 352 and 356, or a combination of these or other components.

While shown in FIG. 3 as being stored in system memory 308, all or a portion of operating system 330, application programs 332, other programs/modules 334, drivers 336, program data 338 and communications 340 can be stored on persistent storage device 320 of internal nontransitory storage systems 318 or removable persistent storage device 326 of optional removable nontransitory storage systems 322.

In some implementations, a user or system administrator (such as the attendant or customer representative noted above) may enter commands and information into controller 202 using one or more input/output (I/O) devices 342. Such I/O devices 342 may include any current or future-developed input device capable of transforming a user action or a received or perceive input signal to a digital input. Example I/O devices 342 include, but are not limited to, a touchscreen, a physical or virtual keyboard, a microphone, a pointing device, or the like. These and other input devices may be connected to processing unit 306 through an interface 346 such as a universal serial bus (“USB”) interface communicably coupled to system bus 310, although other interfaces such as a parallel port, a game port, or a wireless interface or a serial port may be used. A display 370 or similar output device may be communicably coupled to system bus 310 via a video interface 350, such as a video adapter or graphical processing unit (“GPU”), as is generally known in the art.

In some implementations, controller 202 operates in an environment using one or more of network interfaces 356 to couple to one or more remote computers, servers, display devices, and/or other devices via one or more communications channels, for example, one or more networks such as the network 214. These logical connections may facilitate any known method of permitting computers to communicate, such as through one or more LANs and/or WANs. Such networking environments are well known in wired and wireless enterprise-wide computer networks, intranets, extranets, and the Internet.

Further, a database interface 352, which may be communicably coupled to system bus 310, may be used for establishing communications with a database stored on one or more computer-readable media 360. For example, such a database 360 may include a repository for storing information regarding market conditions or historical supply and demand curves as a function of time, etc.

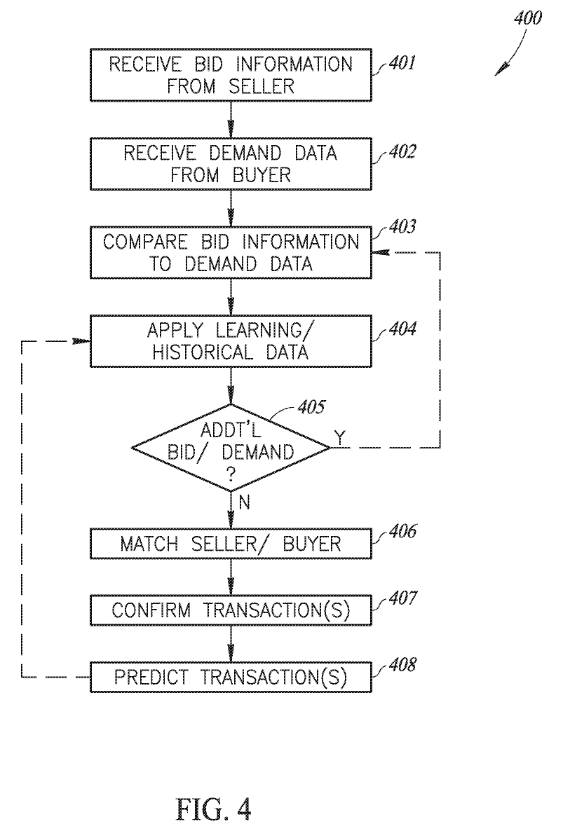

FIG. 4 illustrates a method of sourcing materials, according to at least one illustrated implementation. It will be appreciated that the functionality described below with reference to FIG. 4 may be implemented or executed by or in cooperation with some or all of the components of system 100 illustrated and described above with reference to FIGS. 1 - 3.

Initially, a method 400 of sourcing materials may begin by receiving Bid information from a Seller as indicated at block 401. As noted above, the operation at block 401 may represent reception of Bids from more than one Seller (such as Sellers 110 illustrated in FIG. 1); in fact, system 100 and method 400 may have particular utility in situations where more than one Seller or Producer offers up one or more Bids at block 401, though the disclosed subject matter is not intended to be so limited. Reception as indicated in block 401 may be by server platform 130 or AMLE 140 (such as illustrated in FIG. 1, or both). In implementations in which server platform 130 receives such Bid information, it may be desirable that such information be transmitted or distributed to, or otherwise made available to, AMLE 140.

As noted above, Bid information received at block 401 may include transaction particulars, such as a total quantity available from the candidate Seller submitting the Bid, requested or suggested price per unit or volume, availability date, shipping or carrier information, liability terms, etc. that are or may be relevant to candidate entities (such as Buyers 150 in FIG. 1). This information, a subset of same, or a combination of this information and other data may be received by server platform 130 for storage, further processing, or (typically) both.

Method 400 may proceed by receiving demand data from a Buyer as indicated at block 402. As noted above, the operation at block 402 may represent reception of Bids from more than one Buyer (such as Buyers 150 illustrated in FIG. 1) or a single entity that may own or operate system 100 on a proprietary or exclusive basis. In either implementation, block 402 is intended to indicate that server platform 130 in general, and AMLE 140 in particular, may receive data or other information from one or more Buyers related to demand for a particular product or category of products. As noted above, this may include identification of specific products, families or categories of products, desired or required quantities, purchase prices or price ranges, location or physical address information related to a particular facility owned or operated by a particular Buyer, and the like.

Additionally, it will be appreciated that the operations at blocks 401 and 402 include receiving candidate entity data or other information that may be necessary for consummation of an electronic sales transaction. This information may include, by way of example, credit card numbers, tax identification numbers, billing and shipping addresses, agent or representative names and contact information, insurance carrier information and coverage limitations or parameters, bank account and/or routing information, and the like.

Method 400 may continue by comparing a received Bid (and its attendant transaction criteria or parameters) against other Bids and demand data as indicated at block 403. In that regard, method 400 may employ a server platform or other data processing resources (such as server platform 130) to execute a machine learning algorithm, a predictive analytics engine, or other control or processing logic that attempts to optimize commercial transactions between candidate entities, taking into consideration, for example, historic price learning, price analytics, relative distances between one or more candidate Sellers and one or more candidate Buyers, quantities and estimated quality of product available from candidate Sellers and their locations relative to candidate Buyers, and other commercial considerations. Specifically, machine learning perspective and historical data may be applied to inform the comparison of Bid and demand data as indicated at block 404. In the disclosed implementations, this analytical functionality may be provided by AMLE 140, which may be integrated with or accessible by server platform 130 as illustrated in FIG. 1.

Blocks 403 and 404, both individually and in combination, represent application of sophisticated algorithmic and cross-correlation functionalities intended to identity desirable or optimal matches between one or more candidate Sellers (based upon past and present Bid information or criteria) and one or more candidate Buyers (based upon past and present demand data submitted by Buyers participating in a system such as illustrated in FIG. 1). It will be appreciated by those of skill in the art that certain of the methodologies employed at blocks 403 and 404 may advantageously employ input variables, weighting functions affecting the influence of those variables, historical time periods considered, long-term and transient market conditions, exigent circumstances, and other factors that may influence output of these processes in a manner that may or may not be predictable. In some implementations, operations at block 404 employing historical data and empirical learning techniques may reduce or minimize uncertainty and the effects of the unpredictable nature of overall market conditions.

A determination may be made at decision block 405 whether additional Bids or demand information should or must be considered. If additional Bid information has been received or if additional demand data are presently available for consideration or analysis, method 400 may loop back to block 403 as indicated. This loop is illustrated as a dashed line in FIG. 4 because it may be optional. In some implementations in which a multiplicity of candidate entities are interacting with a server platform (such as that described above with reference to FIG. 1), many Bids and much demand data may be received periodically or intermittently, for example. In the interest of optimizing transactions by successfully matching candidate entities and their respective interests and requirements, it may be desirable to collect and to analyze (at blocks 403 and 404) as much information as is available at any particular moment in time; on the other hand, however, in the interest of consummating transactions in a timely fashion, it may be desirable in some circumstances to limit the amount of data considered and to make a determination using the best data available at the time.

In some implementations, the determination at decision block 405 may be made based upon a volume of data traffic received from candidate entities, for example, it may be simply time-limited (e.g., no Bids or demand data received after a particular time may be considered for analysis at blocks 403 and 404). In other embodiments, Bids, demand data, either, or both may be time-limited by their own terms (e.g., a Bid may only be valid for a particular period of time, or demand data may be presented in such a way that they expire or are deemed withdrawn at a certain time or on a certain date). In such instances, the determination at decision block 405 may be made prior to the termination or expiration of such Bids or demand data, or a determination may be made to allow such Bids or demand data to expire, in which case they may not be considered in subsequent processing.

Method 400 may proceed by connecting or matching one or more Sellers having present or expected inventory (as represented in a received Bid) with Buyers having present or expected necessity (as represented in received demand data) as indicated at block 406. As noted above, this matching may be complex and involve multiple candidate entities on both the sell-side as well as the buy-side. Even in an implementation in which the system 100 illustrated in FIG. 1 is proprietary or unique to a single Buyer, multiple Sellers may be implicated or matched in a transaction that satisfies all of the Buyer’s requirements (in terms of quantity, quality, price, average purchase price, etc.) for a requested volume of product or materials. In embodiments that contemplate or accommodate multiple Buyers, the operation depicted at block 406 may be even more complex, as the volume of product offered in a single Bid may be split or allocated between or amongst Buyers presenting disparate demand data, shipping preferences, time of delivery requirements, and the like. It is noted that the matching functionality illustrated at block 406 may be informed or influenced by historical data (involving transactions between particular candidate entities, for example, involving the same or similar products, or both) in some implementations of method 400.

One or more transactions may be confirmed, and such confirmation of which may be transmitted to all relevant candidate entities, as indicated a block 407. This operation may be effectuated or facilitated in accordance with any of various methods or techniques generally known in the art of electronic commerce or developed and operative in accordance with known principles, and so is not addressed in more detail here. In particular, the present disclosure is not intended to be limited by the authentication procedures, electronic commerce conventions, or legal mechanisms employed to confirm or validate transactions in a financial or cryptographic context, as these features are well known and common in the relevant arts. In some embodiments, a PO may be provided to a successful Seller (as indicated in FIG. 1) and a receipt or other similar or analogous acknowledgement indicative of virtual transaction authentication may be transmitted or otherwise delivered to a successful Buyer. The operation depicted at block 407 is intended to represent an acknowledgement (for example, by server platform 130) that a match between one or more Seller Bids and one or more Buyer requirements has been identified, and that system 100 has allocated product quantities from Sellers’ inventories to fulfill some or all of Buyers’ requirements in accordance with the comparison operation (at block 403) and historical data analysis (at block 404) as set forth above.

As noted above with reference to FIG. 1, a system 100 may employ predictive analyses to facilitate matching of candidate entities’ transactional parameters and requirements. This feature, as executed by method 400, is represented diagrammatically at block 408, though it is noted that such predictive technologies may benefit from access to historical data and those data and information generated by machine learning techniques. In that regard, data associated with a most recent transaction (such as is represented at blocks 406 and 407) may be used at block 408, and may additionally be transmitted, either independently or in addition to any processing results generated at block 408, back to block 404 as indicated by the dashed arrow in FIG. 4.

The arrangement of the blocks and the order of operations depicted in FIG. 4 are not intended to exclude other alternatives or options. For example, the operations depicted at blocks 401 and 402 may occur substantially simultaneously in some implementations; as noted above, Bids and demand data may be received intermittently, periodically, or otherwise on an ongoing basis, and so the operations represented by blocks 401 and 402 may be reversed in order, or may alternate over time, as well. In that regard, the operations depicted at blocks 403 and 404 may occur contemporaneously with the reception occurring at blocks 401 and 402, and may occur substantially simultaneously with each other. Similarly, the confirmation at block 407 may occur concomitantly with or substantially simultaneously with the matching operation at block 406.

In accordance with the foregoing, it will be appreciated that a method of sourcing materials may generally comprise: receiving bid information from a candidate Seller having an inventory of materials; receiving demand data from a candidate Buyer having a need for materials in the inventory; comparing the bid information and the demand data in accordance with historical data related to past transactions and market conditions; matching a portion of the inventory to the candidate Buyer based in part upon the inventory, the need, and the historical data to identify a transaction; allocating the portion of the inventory and routing the portion of the inventory to the candidate Buyer via a transportation carrier; and augmenting the historical data with information associated with the transaction. As noted above, many variations and modifications are possible.

Several features and aspects of a system and method have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the present disclosure be considered as limited only by the scope of the appended claims.

What is claimed is:

1. A method of maintaining a machine-learning based system for sourcing materials; the method comprising:
electronically receiving bid information from each of a plurality of candidate Sellers, the candidate Sellers having an inventory of materials;
receiving demand data from a plurality of candidate Buyers each of the candidate Buyers having a respective need for materials in the inventory;
predicting a future supply in accordance with historical data related to past transactions and market conditions via a machine learning algorithm executing on a processor;
predicting a future demand in accordance with historical data related to past transactions and market conditions via the machine learning algorithm executing on the processor;
comparing the bid information and the demand data in accordance with the predicted future supply and the predicted future demand;
responsive to the comparing, matching one or more portions of the inventory to respective ones of one or more of the plurality of candidate Buyers based in part upon the inventory, the respective need, and the predicted future supply and the predicted future demand to identify one or more transactions;
automatically allocating the one or more portions of the inventory to respective ones of one or more of the plurality of candidate Buyers; and
augmenting the historical data with a respective piece of information associated with the one or more identified transactions for subsequent use by the machine learning algorithm in subsequently training the machine-learning based system, wherein the augmenting includes augmenting the historical data with a value that represents the one or more portions of the inventory that was matched and allocated for the one or more identified transactions, wherein the predicting a future supply and the predicting a future demand are based on the historical data and the respective piece of information associated with the one or more identified transactions and the augmenting is responsive to the predicting.

2. The method of claim 1 wherein the electronically receiving bid information comprises electronically receiving data from a software application executing on a remote device.

3. The method of claim 1 wherein the electronically receiving bid information comprises electronically receiving data from a software application executing on a wireless telephone.

4. The method of claim 1 wherein the electronically receiving bid information comprises electronically receiving data from a software application executing on a tablet computer.

5. The method of claim 1 wherein the electronically receiving bid information comprises electronically receiving data from a software application executing on a networked computing device.

6. A machine-learning based system of sourcing materials; the machine-learning based system comprising:
a server platform to match one or more of a plurality of candidate Sellers having an inventory of materials with one or more of a plurality of candidate Buyers each of the candidate Buyers having a respective need for the materials in the inventory, the server platform communicatively coupled with a plurality of remote devices operated by respective ones of the plurality of candidate Sellers and communicatively coupled with a plurality of remote devices operated by respective ones of the plurality of candidate Buyers;
wherein the server platform comprises a processor and a nontransient computer readable storage medium, the nontransient computer readable storage medium which stores:
processor-executable order module instructions to process demand data received from the candidate Buyers;
a processor-executable application program to process bid information received from the candidate Sellers; and
a processor-executable machine learning algorithm that: predicts a future supply in accordance with historical data related to past transactions and market conditions, predicts a future demand in accordance with historical data related to past transactions and market conditions and compares the bid information and the demand data in accordance with the predicted future supply and the predicted future demand;
the server platform including nontransient data and instructions causing the processor executing the instructions to match one or more portions of the inventory to respective ones of one or more of the plurality of candidate Buyers based in part upon the inventory, the need, the predicted future supply and the predicted future demand, and output from the machine learning algorithm to identify a transaction, to automatically allocate the one or more portions of the inventory to respective ones of one or more of the plurality of candidate Buyers and route the automatically allocated one or more portions of the inventory to the one or more of the plurality of candidate Buyers via a transportation carrier, and to augment the historical data with a respective piece of information associated with the identified transaction for subsequent use by the processor-executable machine learning algorithm to subsequently train the machine-learning based system, wherein the augmentation includes augmentation of the historical data with a value that represents the one or more portions of the inventory that was matched and allocated for the identified transaction, wherein the augmenting includes augmentation of the historical data with a value that represents the one or more portions of the inventory that was matched and allocated for the one or more identified transactions, wherein the predicted future supply and the predicted future demand are based on the historical data and the respective piece of information associated with the one or more identified transactions and the augmenting is responsive to the predicting.

7. The machine-learning based system of claim 6 wherein the order module receives demand data from a software application that executes on one of the remote devices operated by a respective one of at least one of the candidate Buyers.

8. The machine-learning based system of claim 6 wherein the remote device operated by at least one of the candidate Buyer is one of a wireless telephone, a tablet computer, or a networked computing device.

9. The machine-learning based system of claim 6 wherein the application program receives the bid information from a software application executing on the respective remote device operated by at least one of the plurality of candidate Sellers.

10. The machine-learning based system of claim 6 wherein the respective remote device operated by at least one of the candidate Sellers is one of a wireless telephone, a tablet computer, or a networked computing device.

11. The machine-learning based system of claim 10 wherein the nontransient data and instructions cause the processor executing the instructions to store the predicted future supply and the predicted future demand and the respective piece of information associated with the identified transaction for subsequent use by the machine learning algorithm.

12. The method of claim 1, further comprising:
comparing, via a machine learning algorithm, material terms and parameters of newly received bids with historic data maintained and associated with past or pending bids to identify fraudulent bids; and
rejecting an identified fraudulent bid.

13. The method of claim 1, further comprising:
comparing via a machine learning algorithm material terms and parameters of newly received bids with historic data maintained and associated with past or pending bids, to identify mistaken bids.

14. The method of claim 1 wherein the machine learning algorithm automatically learns.

15. The method of claim 1 wherein electronically receiving bid information from each of a plurality of candidate Sellers includes receiving images of at least some of the inventory from the candidate Sellers.

16. The method of claim 1, further comprising:
automatically routing the automatically allocated portion one or more portions of the inventory to one or more of the candidate Buyers via a transportation carrier.

17. The method of claim 1, further comprising:
generating a virtual purchase order memorializing a one of the one or more transactions.
